(19) United States
(12) Patent Application Publication
(10) Pub. No.: US 2008/0218313 A1
(43) Pub. Date: Sep. 11, 2008

(54) RFID-BASED SYSTEM AND METHOD FOR DRIVE-THROUGH ORDERING

(76) Inventors: Loek d'Hont, Port Charlotte, FL (US); Charles T. Coyle, Fort Myers, FL (US); Paul Manuel, North York (CA); Martin Capper, Milton (CA); Wai-Cheung Tang, Mannheim (CA); William P. Montague, Clarence, NY (US); Mark G. Barberio, Williamsville, NY (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/044,783

(22) Filed: Mar. 7, 2008

Related U.S. Application Data
(60) Provisional application No. 60/894,079, filed on Mar. 9, 2007.

(51) Int. Cl. H04Q 5/22; A47F 10/06

(52) U.S. Cl. 340/10.1; 340/286.09

(57) ABSTRACT

A system and method to facilitate drive-through ordering in which two or more options are presented to a customer and an in-vehicle transponder includes an input device to receive customer selection of one of the two or more options. The user selection received via the input device is relayed to the vendor through RF communications between the transponder and a reader.

### RELATED APPLICATION

This application claims the benefit of U.S. provisional patent application Ser. No. 60/894,079, filed on Mar. 9, 2007, entitled “RFID-Based System and Method for Drive-Through Ordering,” which is hereby incorporated by reference in its entirety.

### FIELD OF THE INVENTION

The present invention relates to radio frequency identification (RFID) systems and, in particular, to the use of RFID in drive-through installations to facilitate ordering from within a vehicle.

### BACKGROUND OF THE INVENTION

Vehicle-based RFID communications are commonplace in the context of electronic toll collection (ETC) systems. ETC system conduct toll transactions electronically using RF communications between a vehicle-mounted transponder (a “tag”) and a stationary toll plaza transceiver (a “reader”). An example of an electronic toll collection system is described in U.S. Pat. No. 6,661,352 issued Dec. 9, 2003 to Tiernay et al., and owned in common with the present application.

U.S. Pat. No. 6,366,220 to Elliott, issued Apr. 2, 2002, proposes the use of an ETC tag to order menu items while in a drive-through lane at a vendor location. The customer pre-selects an order using a Web interface and associates the pre-selected order with his or her transponder. Upon detection of the customer's transponder in the drive-through lane, the vendor retrieves the customer's pre-selected order from a database on the basis of its association with the transponder ID, and processes the order. If the customer wishes to modify the pre-selected order, they do so orally through the conventional roadside ordering station.

It would be advantageous to improve the ordering of drive-through items using RFID technology.

### SUMMARY OF THE INVENTION

The present invention provides a system and method for facilitating drive-through ordering using an RFID transponder or tag. The RFID transponder may be active or passive in different embodiments. The RFID transponder facilitates identification of the customer when the vehicle enters a drive-through lane. The identity of the customer may, in some embodiments, be linked to a set of default or pre-defined menus. The customer is presented with two or more menu options, which may be the default or pre-defined menus associated with the customer's identity. The customer then selects from the two or more options.

The selection of options may occur through a variety of mechanisms. In one embodiment, the roadside ordering station may provide a keypad, touchscreen, or other manual input device that the customer may physically actuate.

In another embodiment, the customer may employ a wireless device to communicate with the roadside ordering station or system to communicate his or her choice(s). This solution avoids the necessity of rolling down the vehicle window. One example of a wireless device is an infrared transmitter. Another example is a high frequency (HF) transmitter. Yet another example is an ultra-high frequency transmitter (UHF), specifically a Bluetooth enabled device. Other types of wireless devices for communicating with a wireless receiver connected to the drive through ordering system may also be employed. In some embodiments the RFID transponder or tag used to identify the vehicle may be combined with the wireless device for communicating menu selections. For example, in one embodiment, the RFID transponder may incorporate an input mechanism, such as buttons or keys, for inputting selection data.

In yet another embodiment, the drive through ordering system may employ a call-back mechanism. The customer identity may be associated with contact information for a mobile device, such as a cellular telephone or other handheld wireless device. Upon detecting the identity of the customer through the RFID transponder or tag, the drive through ordering system may initiate a call to the mobile device using the associated contact information. The customer may then enter his or her menu choices via the mobile device. In one embodiment, the customer is connected to an automated voice response system. In another embodiment, the customer is expected to enter DTMF tones based on prompts or queries presented visually at a roadside ordering station. In yet another embodiment, the customer may be connected to a live operator and may place the order orally. In one embodiment, the customer can pay inside as well using an additional means of wireless identification. In yet a further embodiment, the drive through ordering system may employ voice recognition technology in conjunction with an automated voice response system to detect and interpret oral instructions from the customer.

As discussed above, in one embodiment two or more options are presented to the customer and the in-vehicle transponder includes an input device to receive customer selection of one of the two or more options. The user selection received via the input device is relayed to the vendor through RF communications between the transponder and a reader.

In another embodiment, the drive-through ordering system employs an automated ordering system based on a means of automated identification tied into a database and as such, offers a customer loyalty and reward system associated with the particular business. In one embodiment, the automated ordering system uses a centralized database which allows the system to be used throughout nationwide chains of the same business. The automated ordering system may be equipped with a means of transponder authentication using digital signatures. In another embodiment, the transponder device holds multiple identification codes and/or digital signatures to the extent where it can be used by multiple (possibly competing) businesses without revealing (thus shielding) sensitive information from one business to the other. In yet another embodiment, the automated ordering system communicates electronically with existing payment systems such as credit card institutes and/or banks to establish creditworthiness and initiate automated payments.

In one aspect, the present application provides a system for facilitating in-vehicle ordering from a drive-through lane at a vendor's location. The system includes an antenna having a capture zone covering at least a portion of the drive-through lane, a reader connected to the antenna, a vehicle-mounted transponder for engaging in RF communications with the reader, and an order processor for offering at least two orderable items, the order processor being connected to the reader. The transponder includes an input device. The transponder is configured to transmit an RF signal to the reader, and the RF signal includes selection data based upon an input signal from the input device. The selection data indicates selection of one of the at least two orderable items, and the order processor is configured to receive the response signal and process an order containing the one of the at least two orderable items.

In another aspect, the present application provides a method of in-vehicle ordering from a drive-through lane at a vendor's location. The vehicle includes a transponder and the vendor's location includes a reader for engaging in RF communications with the transponder when the transponder is within a capture zone covering at least a portion of the drive-through lane. The transponder has an input device. The method includes steps of offering at least two orderable items, receiving a user input to the transponder through the input device, wherein the user input comprises selection data indicating a selection of at least one of the orderable items, transmitting the selection from the transponder to the reader, and processing an order based upon the selection. Optionally, the transponder device can be equipped with some means of signaling back information (or confirmation) to the patron (LCD display, LEDs, buzzers and the like).

In yet another embodiment, the present invention provides a system for facilitating in-vehicle ordering from a drive-through lane at a vendor's location. The system includes RF reader means for engaging in RF communications within a capture zone covering at least a portion of the drive-through lane, order processing means for offering at least two orderable items, the order processing means being connected to and controlling the reader means, and vehicle-mounted transponder means for engaging in the RF communications with the RF reader means. The transponder means includes input means for receiving user input indicating a selection of one of the at least two orderable items, and includes means to transmit an RF signal including data regarding the selection to the reader means. The order processing means includes means to process an order based upon the selection.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 diagrammatically shows a system for facilitating in-vehicle ordering from a drive-through lane;

FIG. 2 shows, in flowchart form, a method of in-vehicle ordering from a drive-through lane at a vendor's location using a transponder with an input mechanism;

FIG. 3 diagrammatically shows a display screen for displaying menu options to a customer in an embodiment of a drive-through system;

FIGS. 4 to 9 diagrammatically shows the display screen of FIG. 3 in response to selection of various options;

FIG. 10 shows, in block diagram form, an embodiment of a transponder for use in connection with the system of FIG. 1; and

FIG. 11 diagrammatically shows another embodiment of a system for facilitating in-vehicle ordering from a drive-through lane.

Similar reference numerals are used in different figures to denote similar components.

### DESCRIPTION OF SPECIFIC EMBODIMENTS

The embodiments described below focus upon food vendors; however, it will be appreciated that the present application is not limited to food vendors and may find application in connection with other types of vendors that have drive-through locations.

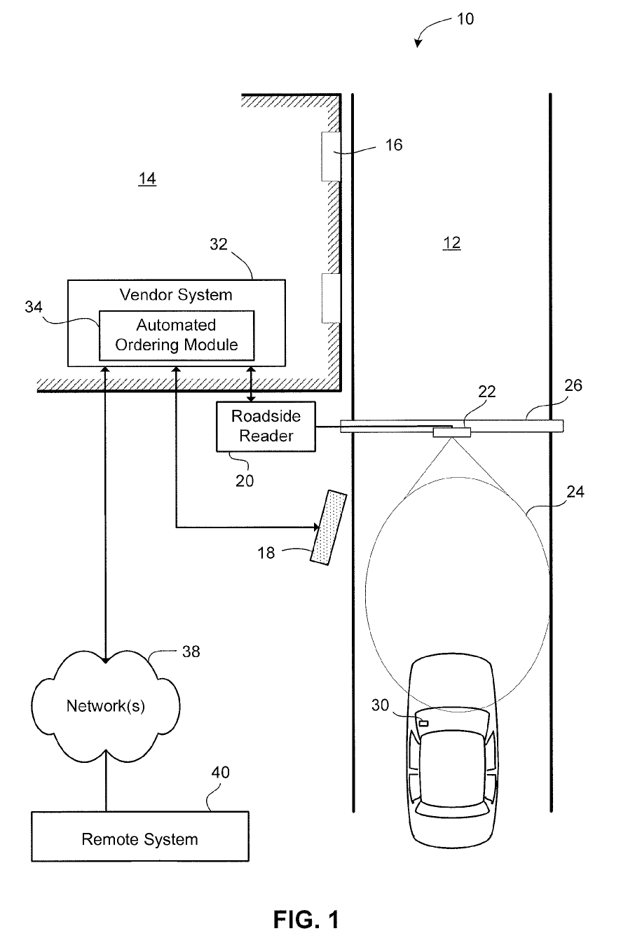

Reference is first made to FIG. 1, which diagrammatically shows a system 10 for facilitating in-vehicle ordering from a drive-through lane 12. The drive-through lane 12 is associated with a vendor location 14, which includes at least one drive-through window 16 through which, conventionally, payment and ordered items are exchanged. In some cases, the vendor location 14 may include more than one drive-through window 16 and payment may be processed at one window while ordered items are received by drive-through customers through another window.

The vendor location 14 may include an ordering station 18 upstream in the drive-through lane 12 from the location of the drive-through window 16. The ordering station 18 typically includes at least a microphone and a speaker. It also typically includes a display of available items which the customer may order. For example, a food vendor typically situates a menu board at the ordering station 18 to present the customer with the available food options. The customer is expected to review the menu items, roll down his or her vehicle window, and orally place an order by speaking into the microphone. An employee within the vendor location that is responsible for processing drive-through orders is usually provided with a headset and microphone for communicating with the drive-through customer via the ordering station 18. Low quality of the microphones and speakers and the noisiness of the environment can lead to difficulties in understanding the oral communications and consequent ordering errors.

In some cases, the ordering station 18 may include a display screen. Based on the oral exchange via the ordering station 18, the drive-through employee enters the customer's order into the vendor's computerized order system. The order, as entered, is displayed to the customer on the display screen, which allows the customer to review the order, view the payment required, and request any changes necessary as a result of misunderstandings.

The in-vehicle ordering system 10 provides for a roadside reader 20 and an antenna 22. The antenna 22 is a directional antenna having a beam path that defines a capture zone 24 at least partially within the drive-through lane 12. The antenna 22 may be mounted on an overhead gantry 26, as shown, or on a roadside structure at the side of the drive-through lane 12. In one embodiment, the antenna 22 may be located beneath the drive-through lane 12. In some embodiments, more than one antenna may be connected to the roadside reader 20 for communicating with transponders in the drive-through lane 12.

The system 10 also includes a vehicle-mounted transponder 30. The transponder 30 may be mounted to the inside of the vehicle windshield, to a license plate, or in another location on the vehicle that permits the transponder 30 to engage in RF communications with the reader 20.

The capture zone 24 is an area within which the transponder 30 and reader 20 may engage in RF communications via the antenna 22. The antenna 22 is mounted such that the capture zone 24 includes at least a portion of the drive-through lane 12. The capture zone 24 may, in some embodiments, include an area of the drive-through lane 12 upstream from the ordering station 18 to ensure that communications between the reader 20 and the transponder 20 are completed prior to or during the customer's arrival at the ordering station 18.

The transponder 30 and the reader 20 employ a predefined RF communications protocol. In one embodiment, the protocol provides that the reader 20 transmit a polling or trigger signal of predefined duration within the capture zone 24. If a transponder 30 is present within the capture zone 24 and it receives the polling signal, then it responds by transmitting a response signal. The response signal may have a defined format and may include transmission of data stored in the transponder memory. In some cases, the reader 20 may be configured to send a programming signal instructing the transponder 30 to alter or save certain data in its memory. In some cases, the reader 20 may be configured to send data to the transponder 20 within its polling signal. The range of possible protocols will be appreciated by those skilled in the art of reader-transponder RF communications. The transponder may use any one of a number of possible frequency ranges. Examples include 915 MHz, 5.9 GHz, 13.56 MHz ISM band, LF ISM band, DSRC, and others; although the present application is not limited to particular frequencies.

In accordance with one aspect of the present application, the transponder 30 includes an input mechanism. The input mechanism may include any input device for receiving user input to the transponder 30. In some embodiments, the input mechanism may include one or more buttons, a keypad, a keyboard, switches, a touchscreen, etc. In one embodiment, the input mechanism may include a microphone and voice-recognition software. Other possible input mechanisms will be apparent to those skilled in the art. The transponder also can be equipped with output means for the system to signal back information to the patron.

In one embodiment, the transponder 30 is integral with the vehicle and may be installed by a vehicle manufacturer or after-market supplier. In such an embodiment, the input device may be shared with other vehicle systems. For example, the input device for the transponder 30 may include buttons that are also used to configure and control the vehicle audio system. Other examples will be apparent to those skilled in the art.

The input mechanism permits the transponder 30 to receive user input regarding available menu items. In other words, the input mechanism facilitates in-vehicle user selection between menu options which is then signaled back to the roadside reader through the transponder. The input mechanism may also permit the input of a user acceptance command, a user request for changes, and a cancellation command.

Advantageously, using the input mechanism, the user may make menu selections and indicate his or her choices from within his or her vehicle through the transponder 30, without the necessity of communicating through the speaker/microphone at the ordering station 18.

The vendor location 14 typically includes a computer-based vendor system 32 for electronically managing orders and payment. The vendor system 32 is usually configured as a network of terminals and display screens. The employees that staff the in-store point of sale terminals enter orders placed by the in-store customers into the vendor system 32 and conduct any payment transactions, including cash, debit, and/or credit transactions through the point of sale terminal. The input order placed in the vendor system 32 is displayed to the food preparation staff, along with all other pending orders, to guide the food preparation staff in prioritizing which orders require preparation. Similarly, the employee or employees managing drive-through orders enter the order data through a point of sale terminal. The food preparation staff prepare the order. Payment for the drive-through order is processed through a terminal at the drive-through window 16, and may include payment via cash, debit and/or credit.

The in-vehicle ordering system 10 may be integrated within the vendor system 32. The degree of integration may vary in different embodiments. In one embodiment, the vendor system 32 includes an automated ordering module 34 that is configured to communicate with the roadside reader 20. The automated ordering module 34 may provide the roadside reader 20 with menu data, pricing data, and other such data for communication to the transponder 30. The roadside reader 20 may send the automated ordering module 34 transponder ID data, selection data, and other such data.

In one embodiment, the system 10 is implemented as a stand-alone system specific to the vendor location 14. However, in many embodiments, the system 10 is one of many such systems at a number of vendor locations. Accordingly, portions of the system 10 or its data may be centralized at a remote system 40, which may include or be implemented by a server and/or database. The automated ordering module 34 may include a component for communicating with the remote server 40 over a network 38. The network 38 may include wired or wireless networks, public or private networks, or any combination thereof. In many embodiments the network 38 may include the Internet.

The remote server 40 may store data, in database form or otherwise, regarding each transponder and/or account established. For example, for each account the data stored at the remote server 40 may include a transponder ID, associated user data, such as a username and password, and payment information, such as credit card details. In one embodiment, the remote server 40 may also include vendor-specific data for a given account. For example, the remoter server 40 may store data regarding user preferences for a specific vendor. In one example, the user preferences may include one or more default menu choices for the specific vendor specific to the user. The default menu choices may include a set of preferred orders pre-defined by the user or determined by the remote system 40 based upon previous orders by the user, as will be explained further below. In the case of the callback feature, the database will also contain the patron's mobile phone number which was given by the patron when signing up for the service.

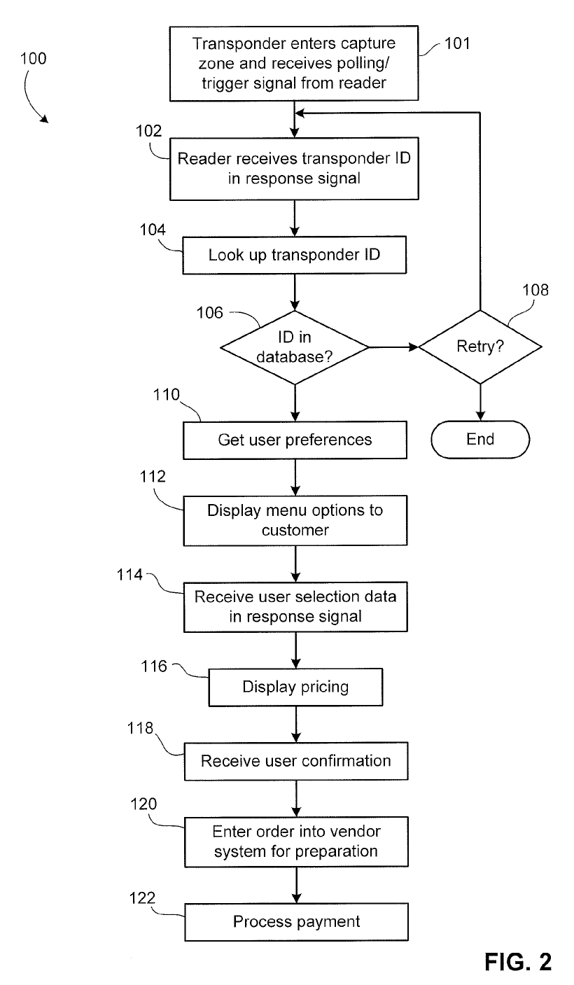

Reference is now made to FIG. 2, which shows, in flowchart form, a method 100 of in-vehicle ordering from a drive-through lane at a vendor's location using a transponder with an input mechanism.

The method 100 begins in step 101 with a vehicle equipped with a transponder entering the capture zone within the drive-through lane. Upon entering the capture zone, the transponder receives a polling or trigger signal broadcast by the reader. In step 102, the transponder sends data to the reader in a transponder RF communication. In many embodiments, this occurs in response to a trigger or polling signal. The data includes, among other things, the transponder ID. In some embodiments, the data may include other identifiers in place of, or in addition to, the transponder ID. For example, it may include a customer name, a customer ID number, vehicle data, or other identification information through which the system will be able to determine the identity of the customer. The lane equipment could also be equipped with systems like license plate recognition systems as a means of backup ID verification.

In step 104, the system looks up the transponder ID in a database or other memory. The database may be local for stand-alone vendor-specific systems. In many embodiments, the database may be located at a remote system. In such an embodiment, the drive-through system at the vendor location may send its system ID and the transponder ID to the remote system with a look-up query. The remote system responds if it locates the transponder ID within its database, thereby indicating a valid customer. In some cases, the remote system many only confirm the validity of the customer if the associated database record indicates that the customer has also pre-authorized the vendor making the query. In other words, the customer may pre-select vendors with whom the customer agrees to use his or her transponder when in drive-through lanes. Advantages of a centralized database are the feature of identifying and serving the customer at different locations instead of just one local store, which is of advantage for business chains.

In step 106, the system assesses whether it has located the transponder ID, or other customer identifier, in a database, whether local or remote. If not, then the transponder ID may not correspond to an active account/customer, it may have been de-activated for non-payment, or the vendor may not be pre-authorized to conduct automated RF ordering with this particular transponder/customer. In some cases, the reader may have received an erroneous transponder ID due to a bit error caused by reflections, cancellation, or other RF interference problems. Accordingly, in step 108, the system may elect to re-obtain the transponder ID. It will be appreciated that other error checking and/or error correction mechanisms may be employed within step 102. For example, the RF protocol may call for the use of parity bits, CRC or other error detection mechanisms or forward error correction mechanisms.

If the transponder ID is not validated through step 106, and no additional re-tries are performed, then the system requires the user to place his or her order manually via the ordering station. A misread or error message may be sent to the transponder, which may illuminate an error LED, display an error message, and/or emit an error tone to indicate to the vehicle occupant that the automated ordering system was unable to validate the transponder and any orders must be placed manually. Alternatively, the error message or alert may be visually indicated by a light or display screen external to the vehicle (e.g., at the side of the drive-through lane, to alert the vehicle occupants to the need to order manually).

If the transponder ID is verified in step 106, then the system may obtain user preferences for the specific vendor, as indicated in step 110. In the case where the system is a vendor-specific stand-alone system, the user preferences may be stored in association with the transponder ID within the vendor system. In other embodiments, the user preferences may be sent by the remote system to the vendor system over the network. The remote system may send the drive-through system the user preferences when it sends confirmation that the transponder ID is valid. In another embodiment, the remote system may await a further query from the drive-through system before sending user preferences. It will be appreciated that the remote system may store a database record for a given transponder and/or customer that includes user preferences associated with plurality of vendors. The remote system only transmits the user preferences relevant to the vendor associated with the drive-through system. Suitable authentication and/or encryption protocols may be employed for any communications between the remote system and the drive-through system.

It will be appreciated that some embodiments of the system/method may not store user preferences and, accordingly, step 110 may be omitted in operation of those embodiments.

In step 112, the ordering options are presented to the customer. In different embodiments, this may take place in a variety of ways. For example, in one embodiment, the menu options are simply visually displayed on one or more external signs at the roadside. The external display may include printed menu signage and/or video screens.

In another embodiment, data presented on the external display is customized based upon the user preference data. For example, where the user preference data indicates one or more default orders, the default orders may be displayed and offered for selection. In one embodiment, the default orders may be displayed textually on a roadside LED display, or another such visual text output device.

In yet another embodiment, the drive-through system transmits menu options as RF data to the transponder and the transponder displays menu options to the vehicle occupants through a visual output device. For example, in the case where user preferences may be used to tailor the available menu to a subset of default orders, the reader may transmit the default orders to the transponder. The transponder may then output the default orders on a display device within the vehicle, such as an LED display or a display screen. The display device may be incorporated as a part of the transponder, may be a separate device mounted within the vehicle, or may be provided as an integral part of the vehicle, such as a display screen incorporated into the dashboard design of the vehicle.

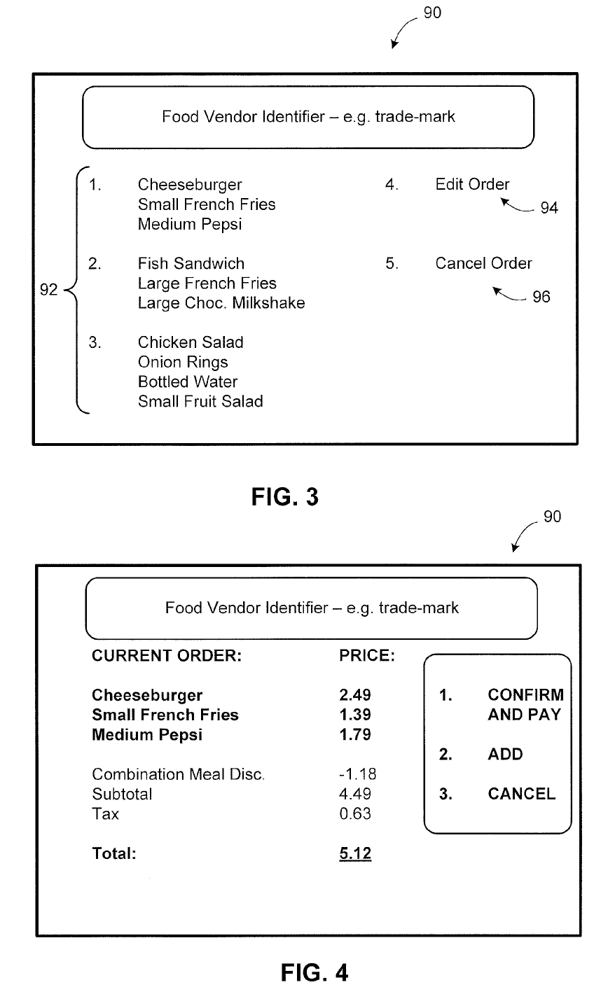

By way of illustration, a sample default menu display 90 is shown in FIG. 3. It will be noted that the sample default menu display 90 includes three default options 92, which are numbered 1 to 3, an edit option 94, and a cancel option 96. In another embodiment, the entire menu or a portion of the menu of the vendor may be transmitted to the transponder for display to the user.

Referring again to FIG. 2, the user provides input to build an order in step 114. In one case, this includes selecting one of the default options. In another embodiment, this includes selecting the individual menu items desired. The input is provided by way of the transponder input device. As discussed above, the input device may, in various embodiments, include buttons, a key pad, a keyboard, a touchscreen, or various other mechanisms for indicating the user's choices. The transponder transmits the input user selections to the reader as selection data within a response signal.

It will be appreciated that steps 112 and 114 may include a variety of display and select iterations as the user selects items or sub-menus and the display of available items is updated based upon user selections. In this sense, the transponder and reader may engage in a dialog to arrive at a selected order, with the transponder relaying user menu selections to the reader based upon the input data received via the input device.

In step 116, the price associated with the selected order is displayed to the customer. Again, the price may be on a roadside external display screen or the price data may be transmitted to the transponder for display on an in-vehicle display device. It will also be appreciated that the price may be displayed throughout steps 112 and 114 as the user makes additional selections. In step 118 the user inputs approval of the selected order and price via the transponder input device. The user input is transmitted to the reader to confirm the user order and confirm the user intention to process payment for the order.

In step 120, the selected and confirmed order is entered into the vendor system, so as to alert the food preparation staff to the need to prepare the order for pick-up at the drive-through window.

In step 122, payment for the order is processed. Payment processing may be carried out in a variety of ways. For example, payment may be made by way of a credit card that has previously been linked to the transponder ID during establishment of the customer account. The credit card data may be transmitted from the remote server to the vendor location for processing by the vendor system in accordance with its normal procedures. Alternatively, the vendor system may request payment through the remote system, which may execute the functions necessary to charge the pre-designated credit card for the price of the order. Confirmation of the completed transaction may then be sent from the remote system to the vendor location. In another embodiment, the customer may have an account with the entity providing the remote system and the vendor system may request payment from the entity, which in turn debits the user account and forwards payment to the vendor. In yet another embodiment, the user may conduct payment in the conventional manner using cash, debit, and/or credit cards through a drive-through window.

Reference is now made to FIG. 3, which diagrammatically shows the display screen 90 for displaying menu options to a customer in an embodiment of a drive-through system. The display screen 90 may be an external display screen mounted to a roadside menu board in one embodiment. In another embodiment, the display screen 90 may be located within the vehicle in the drive-through lane as a part of the vehicle-mounted transponder or mounted to or in the vehicle dashboard. In the former embodiment, the display screen displays menu data supplied by the vendor system or the roadside reader. In the latter embodiment, the reader sends menu data to the transponder in an RF signal and the transponder outputs menu data to the display screen 90 for display to the vehicle occupants.

In the embodiment illustrated in FIG. 3, the display screen 90 shows three default menu orders 92. These default menu orders 92 may be determined based upon the user preferences found in a database record corresponding to the transponder ID/customer presently detected within the drive-through lane. The user preferences may be pre-established by the user through, for example, a Web interface with the database. In another embodiment, the user preferences are determined or altered dynamically by tracking previous orders associated with the transponder ID/customer and modifying the user preferences to reflect the orders that the customer most frequently places. The algorithm for determining the user's preferred orders may include a weighting function to give greater effect to the most recent orders made by the customer.

In addition to the default menu orders 92, the display screen 90 also includes an edit command 94 and a cancel command 96. In this embodiment, the display screen presents five options to the customer; however, it will be appreciated that in other embodiments more or fewer choices may be displayed. In this embodiment, the choices are numbered to facilitate easy selection by the user using a numerical keypad or button(s) on the transponder. For example, the user may press a key or button corresponding to the number of the desired choice on the display screen 90. In another embodiment, the transponder may include arrow keys/buttons and a select key/button and the display screen may highlight one of the options. Using the arrow keys/buttons, the customer may cycle through the available options until the desired option is highlighted. The customer may then select the highlighted option by pressing the select key/button. In yet another embodiment, where the display screen 90 is an in-vehicle screen, the customer may select options using a touchscreen function of the in-vehicle screen.

In some embodiments, the edit command 94 may be provided to enable the user to select/build an order other than the default menu orders 92 displayed. In one embodiment, the edit command 94 permits alterations to the default menu orders 92. In another embodiment, the edit command 94 may permit the customer to build an entirely new order by selecting individual items from the vendor menu.

The cancel command 96 may be provided to allow the customer the option of ordering manually using the ordering station. Selection of the cancel command 96 may result in transmission of a message from the transponder to the reader indicating that the customer does not wish to use the automated drive-through system and will order manually through the microphone at the ordering station.

Reference is now made to FIG. 4, which shows the display screen after selection of one of the default menu orders 92. In the example shown in FIG. 4, the customer has selected option 1 corresponding to the first of the default menu orders 92. The display screen 90 shows the current order, including the items comprising the order, the individual prices, the subtotal, etc. In this embodiment, the display screen 90 also provides the user with three selections: confirm and pay, add, or cancel. If the user selects “confirm and pay”, then the order is processed as it is presented.

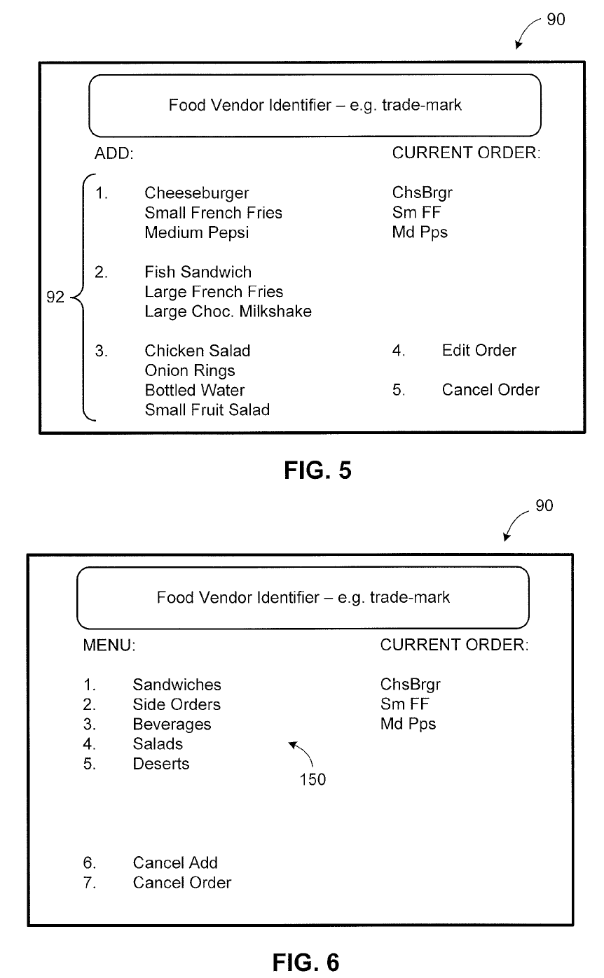

If the user selects “add”, then the user may be presented with a display such as is shown in FIG. 5. In FIG. 5, the default menu orders 92 are again presented to the user to enable the user to select another default order. This may arise when the vehicle contains more than one occupant. The display screen 90 may also show the current order.

In this embodiment, the user may also be presented with an “edit order” option to enable further customizing of the order. For example, selection of the “edit order” option may allow the user to select individual menu items rather than selecting from the default menu orders 92.

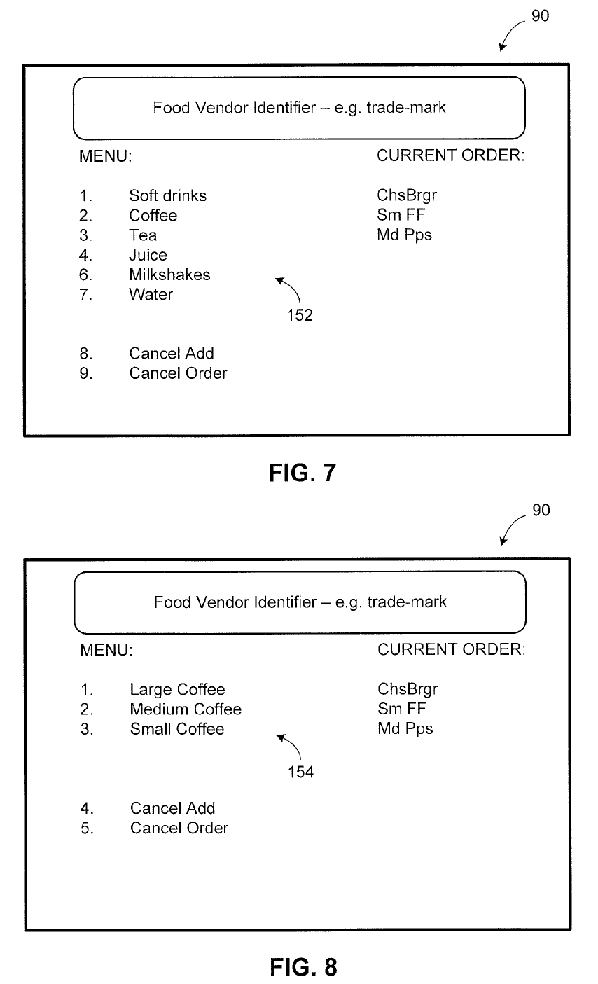

As shown in FIGS. 6, 7, and 8, the user may, in one embodiment, navigate through hierarchies of menus in making individual selections. In FIG. 6 a top level menu 150 is displayed. Upon selection of a category, such as “beverages”, a next level menu may be displayed. For example, as illustrated in FIG. 7, a beverages menu 152 may be displayed. Upon further selection of a category from within the beverages menu 152, such as “coffee”, a bottom level menu may be displayed. For example, as illustrated in FIG. 8, a menu item list 154 may be presented from which the user may select individual items.

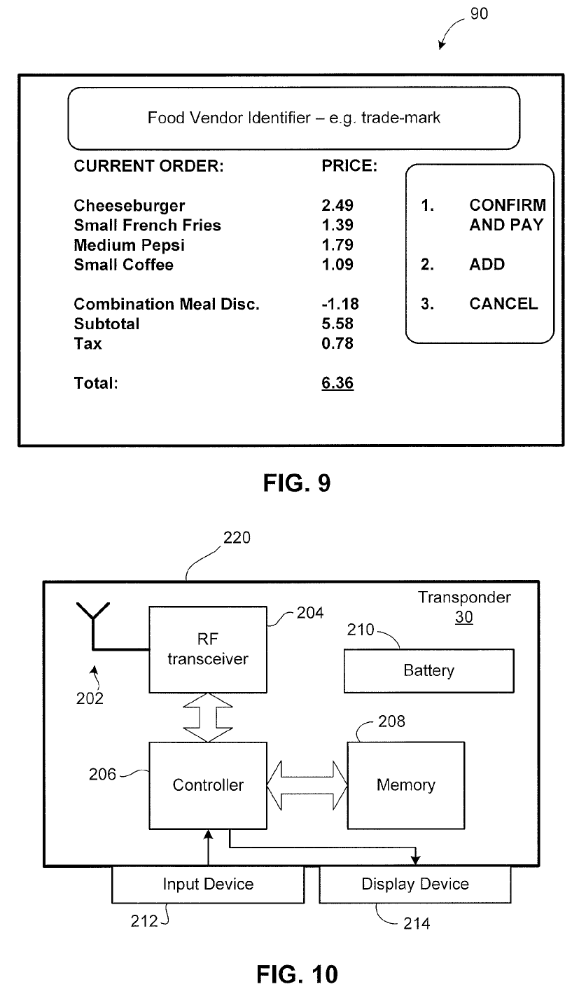

FIG. 9 illustrates the display screen 90 after selection of a “small coffee” to be added to the first default menu order. The user is again prompted to “confirm and pay”, “add” or “cancel”.

It will be appreciated that the quantity of text and other information that may be displayed to the user, and thus the range of options that may be made available, may be partly determined by the display capabilities at the ordering station or within the vehicle.

Reference is made to FIG. 10, which shows, in block diagram form, an embodiment of the transponder 30 for use with the drive-through ordering system 10.

The transponder 30 includes a transponder antenna 202, an RF transceiver 204, a controller 206, and memory 208. The transponder antenna 202 and RF transceiver 204 enable RF communications with a roadside reader in accordance with a predefined protocol. The antenna 202 is, in many embodiments, housed within a transponder casing 220, although in some embodiment, the antenna 202 may be external to the casing. The transponder casing 220 may be mounted to the interior of a vehicle windshield or elsewhere on or within the vehicle in a location that permits RF communications with the roadside reader.

The RF transceiver 204 performs typical transceiver functions including up-conversion or down-conversion, demodulation, modulation, and suitable filtering and A/D conversion. The RF transceiver 204 operates under the control of the controller 206, which interprets the signals received by the RF transceiver 204 from the roadside reader and which instructs the RF transceiver 204 to send a response and provides the transponder data for inclusion in a response signal. The controller 204 also reads transponder data stored within the memory 208 and may, in some embodiments, write or update data in the memory 208.

In some embodiments, the transponder 30 further includes a battery 210 or other power source. In other embodiments, the transponder 30 may be a passive transponder having no internal power source and relying upon backscatter modulation of a continuous wave transmission from the roadside reader to communicate. In yet other embodiments, the power source for the transponder 30 may be external to the transponder 30 itself. For example, the transponder 30 may draw power from the vehicle, such as from the vehicle on-board power system.

The transponder 30 may, in some embodiments, include a display device 214. The display device 214 may integrated within the transponder casing 220 or may be separate from the transponder casing 220. For example, the display device 214 may be integrated within the vehicle dashboard systems.

The transponder 30 includes an input device 212 for receiving user selections and commands. The input device 212 is connected to and provides input signals to the controller 206. The input device 212 may include any suitable mechanism for generating an input signal in response to user actuation. For example, the input device 212 may include one or more buttons or switches on the transponder casing 220, a keypad, a keyboard, a trackwheel or trackball, or other such devices. In one embodiment, the input device 212 is integrated with the display device 214 as a touchscreen. In yet another embodiment, the input device 212 comprises a microphone and voice recognition software executed by the controller 206. Other possible input devices will be apparent to those skilled in the art.

It will also be appreciated that the input device 212 may be implemented external to the transponder casing 220. For example, the input device 212 may be implemented by way of other vehicle input systems, such as the vehicle stereo/radio interface, or various buttons or keys on the steering wheel or steering column. These other vehicle input systems may be connected to the transponder 30 and may supply the input signal(s) to the controller 206. The connection may be wired or wireless. For example, a suitable short-range wireless connection may be used, such as a Bluetooth connection.

The transponder 30 may, in some embodiments, be used to conduct ETC transactions. In this regard, the transponder 30, and specifically the RF transceiver 204 and controller 206, may be configured to communicate in accordance with a pre-defined ETC communications protocol. Such a protocol may include defined read-program-verify cycles for the communications between readers and transponders. The communications between transponders and readers may be based upon the reader transmission of a polling or trigger signal, in response to which a transponder transmits transponder data in a response signal. The transponder data may be a pre-defined data structure stored in the memory 208 of the transponder 30 and read by the controller 206 for inclusion in a response signal. The pre-defined data structure for transponder data in an ETC protocol typically includes designated fields for transponder ID, vehicle type, last point of entry into a toll road, time of entry, and other such data relating to toll calculation and processing.

In such an embodiment, the pre-defined data structure may also include one or more fields that are available for use by applications other than ETC. For example, the data structure may include a “scratch pad” or “payload” field for containing unspecified data. For ease of reference, this type of field will be referred to herein as an unallocated data field. In such an embodiment, the user selection data received by the controller 206 via the input device 212 may be recorded in the unallocated data field. Accordingly, when responding to a reader polling or trigger signal, the transponder 30 transmits the transponder data found in memory 208 to the reader, including the user selection data recorded in the unallocated data field. In this manner, an ETC-based transponder may be employed to implement the in-vehicle drive-through ordering system and method described herein, provided the ETC-based transponder includes an input device.

In the above-described examples, a user makes menu selections via an in-vehicle input mechanism and those choices are communicated to the drive-through ordering system through the same RF reader-transponder link that was used to identify the customer when the vehicle entered the drive-through lane. In another aspect of the present application, the customer is identified based on an RFID tag or transponder when the vehicle enters the drive-through lane; however, the selection of menu options is facilitated through a separate mechanism.

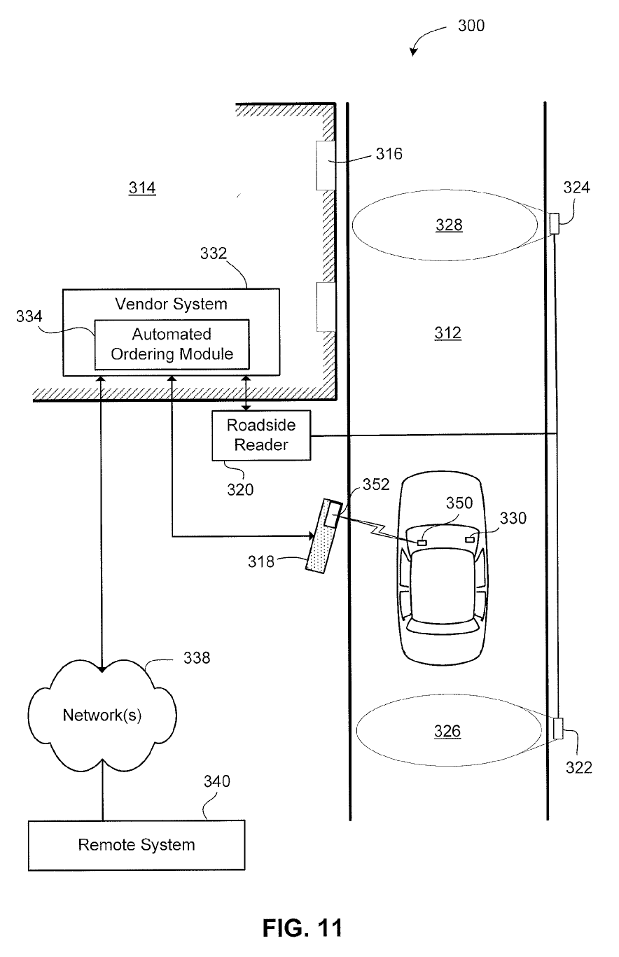

Reference is made to FIG. 11, which diagrammatically shows another example embodiment of an in-vehicle ordering system 300. The system 300 may include a roadside reader 320 and, in this embodiment, two antennas 322 and 324 for RFID communications. One of the antennas 322 may define a first capture zone 326 in the drive-through lane 312 upstream of an ordering station 318. The first capture zone 326 is for identifying customers as they enter the drive-through lane, and the area where the patron places the actual order. The second capture zone 328 defined by the second antenna 324 may facilitate payment using the RFID system, if applicable. The second capture zone 328 may be located downstream of the ordering station 318 at or before the point-of-sale (POS) window 316.

The RFID transponder 330 may include a passive or active UHF transponder or tag in some embodiments. In yet other embodiments, the RFID transponder 330 may include a passive HF tag. In an example embodiment, the passive HF tag may include a sticker tag issued by the vendor that the customer may apply to the windshield of his or her vehicle. In one example embodiment, the reader-transponder communications are based on 13.56 MHz technology.

In this embodiment, a separate wireless device is used to communicate menu option selections with the automated ordering module 334. In particular, the customer operates a small short range transmitter 350. In one embodiment, the transmitter 350 may include an infrared handheld device having one or more input buttons or keys. The device may be similar in nature to a conventional garage-door opener. In another embodiment, the transmitter 350 may include an RF transmitter, similar in nature to a conventional remote-keyless entry device or keyfob. In yet other embodiments, the transmitter 350 may be incorporated within another handheld device, including a mobile telephone, a personal digital assistant (PDA), or other such devices as may contain a short range communication transmitter, which could be in the form of (but not limited to) a Bluetooth device

The automated ordering module 334 is connected to a wireless receiver 352. In one embodiment, the wireless receiver 352 is located within or proximate the ordering station 318. The wireless receiver 352 detects and/or receives signals from the wireless transmitter 350. For example, in one embodiment the wireless receiver 352 detects infrared signals transmitted by an infrared transmitter device actuated by the customer. The wireless receiver 352 may perform suitable demodulation, signal conditioning, and/or decoding of received signals. Based on the wireless signals received by the wireless receiver 352 from the wireless transmitter 350, the automated ordering module 334 is provided with user selection data regarding the menu options presented to the user.

In one alternative embodiment, the wireless transmitter 350 may transmit a unique identification code along with selection data, thereby allowing the automated ordering module 334 to associate the selection data with a given customer. In such an embodiment, it may be possible to eliminate the RFID transponder 330 for identifying the customer if the customer is prompted to use his or her wireless transmitter 350 on approaching the ordering station 318.

In another aspect, the in-vehicle ordering system may utilize a call-back feature to facilitate in-vehicle ordering. In an embodiment according to this aspect, the system identifies the customer based on an RFID tag or transponder, as shown in FIG. 11, and the customer identity is associated with a mobile telephone number that the customer provided upon registering with the vendor. The automated ordering module 334 or another such component of the system retrieves the mobile telephone number and dials the customer through a third party wireless network, such as a cellular or PCS network. Upon answering the call on his or her mobile phone, the customer is then given the opportunity to communicate his or her menu option selections via the mobile phone.

In one embodiment, the system dials the customer's mobile phone number and connects the customer with order entry personnel. The order entry personnel may be local or may be at a remote location. The order entry personnel take the customer's order and enter it into the vendor's order entry system.

In another embodiment, the system dials the customer's mobile phone number and connects the customer with an automated voice response system. The automated voice response system may prompt the user to entry menu selections. The automated voice response system may detect and respond to DTMF digits entered by the user using the dialpad or keypad of his or her mobile phone or PDA. In another embodiment, the automated voice response system may detect and respond to voice input from the user. In other words, the automated voice response system may employ voice recognition algorithms to identify user selections. It will be appreciated that other mechanisms for receiving user input via a wireless communication session over a third party network may also be employed.

It will be appreciated that the call-back facility may or may not be associated with pre-defined user preferences. In other words, the user may or may not have a set of default menu options pre-associated with his or her identity. Using the call-back facility, in particular an embodiment in which the user speaks to order entry personnel, the customer may orally communicate his or her menu selection based on the full vendor menu.

In yet a further aspect, another embodiment of the system may provide for manual input of menu selections by the customer at the ordering station. RFID tags or transponder may be used for customer identification, based on which the system may then provide menu options to the customer via the ordering station. The ordering station may include a manual input mechanism, such as a keypad or touchscreen, through which the customer may manually indicate his or her selection.

Although most of the foregoing embodiments contemplate the use of RFID technology to facilitate drive-through ordering, it will be appreciated that the same or similar technology may optionally be used to transact in-store ordering and purchases. For example, the RFID technology may be incorporated into a handheld device that a customer may carry into a point-of-sale location. Within the vendor's facility, a reader may be positioned so as to detect in-store RFID tags and, thus, to identify customers. The handheld device may include an infrared or RF transmitter for transmitting customer menu selection information. The handheld device may be a dedicated keyfob for this purpose, or may be a multipurpose handheld device that also incorporates an infrared or RF communications capability, such as a mobile telephone, PDA, or other such device.

Those of ordinary skill in the art will appreciate that other data may be associated with a customer in the database, including loyalty program information, credit and payment preference information, or information regarding additional participating members associated with the customer like family members, which information may include the menu preferences of the family members. Other customer-specific information may also be included. This information may be used to tailor the customer experience within the drive-through in other manners, such as targeted advertising, customized greetings, loyalty program status updates, and other features.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for facilitating in-vehicle ordering from a drive-through lane at a vendor's location, the system comprising:
an antenna having a capture zone covering at least a portion of the drive-through lane;
a reader connected to the antenna;
a vehicle-mounted transponder for engaging in RF communications with the reader, the transponder having an input device; and
an order processor for offering at least two orderable items, the order processor being connected to the reader,
wherein the transponder is configured to transmit an RF signal to the reader, and wherein the RF signal includes selection data based upon an input signal from said input device, and wherein said selection data indicates selection of one of said at least two orderable items,
and wherein said order processor is configured to receive said response signal and process an order containing said one of said at least two orderable items.

2. The system claimed in claim 1, wherein said at least two orderable items comprise at least one default order, the at least one default order including two or more menu items.

3. The system claimed in claim 2, further including a server having a memory storing said at least one default order in association with said transponder, and wherein said at least one default order is defined at least partly based upon previous orders associated with said transponder.

4. The system claimed in claim 1, further including a roadside display connected to said order process for receiving and displaying information regarding said at least two orderable items.

5. The system claimed in claim 1, further including a display within the vehicle connected to said transponder for receiving data from said reader via an RF transmission, wherein said RF transmission includes data regarding said at least two orderable items, and wherein said transponder is configured to control said display to display said data regarding said at least two orderable items.

6. The system claimed in claim 1, wherein said input device comprises a device selected from the group including a button, a switch, a keypad, a keyboard, a trackball, a trackwheel, and a touchscreen.

7. The system claimed in claim 1, further including a remote database connected to said order processor over a network, said remote database containing a record associating said transponder with a user identity, payment information, and at least one menu item, and wherein said order processor is configured to obtain said at least one menu item from said remote database, and wherein said at least two orderable items includes said at least one menu item.

8. The system claimed in claim 1, wherein said transponder is configured to operate in accordance with an electronic toll collection communications protocol, and wherein said transponder includes a controller and RF transceiver configured to send said RF signal to said reader in response to a polling signal from said reader, and wherein said response signal includes transponder data and said selection data.

9. The system claimed in claim 8, wherein said transponder data comprises data structured in accordance with a predefined ETC data structure, wherein said data structure includes an unallocated data field, and wherein said unallocated data field contains said selection data.

10. A method of in-vehicle ordering from a drive-through lane at a vendor's location, the vehicle including a transponder and the vendor's location including a reader for engaging in RF communications with the transponder when the transponder is within a capture zone covering at least a portion of the drive-through lane, the transponder having an input device, the method comprising steps of:
offering at least two orderable items;
receiving a user input to the transponder through the input device, wherein the user input comprises selection data indicating a selection of at least one of said orderable items;
transmitting said selection from the transponder to the reader in an RF signal; and
processing an order based upon said selection.

11. The method claimed in claim 10, wherein said at least two orderable items comprise at least one default order, the at least one default order including two or more menu items.

12. The method claimed in claim 11, further including a step of retrieving said at least one default order from a memory based upon an association between said at least one default order and said transponder.

13. The method claimed in claim 12, further including a step of defining said at least one default order at least partly based upon previous orders associated with said transponder.

14. The method claimed in claim 10, wherein said step of offering comprises displaying information regarding said at least two orderable items on a roadside display screen.

15. The method claimed in claim 10, wherein said step of offering comprises transmitting data regarding said at least two orderable items from the reader to the transponder, and displaying said data regarding said at least two orderable items on a display screen within the vehicle.

16. The method claimed in claim 10, wherein said input device comprises a device selected from the group including a button, a switch, a keypad, a keyboard, a trackball, a trackwheel, and a touchscreen.

17. The method claimed in claim 10, wherein a remote database contains a record associating said transponder with a user identity, payment information, and at least one menu item, and wherein said step of offering includes accessing said remote database and retrieving said at least one menu item, and wherein said at least two orderable items includes said at least one menu item.

18. The method claimed in claim 10, wherein said step of transmitting includes receiving a polling signal from the reader to the transponder and, in response, propagating said RF signal from the transponder to the reader, wherein the response signal includes transponder data and said selection data.

19. The method claimed in claim 18, wherein said transponder data comprises data structured in accordance with a predefined ETC data structure, wherein said data structure includes an unallocated data field, and further including a step of writing said selection data into said unallocated data field.

20. A system for facilitating in-vehicle ordering from a drive-through lane at a vendor's location, the system comprising:
RF reader means for engaging in RF communications within a capture zone covering at least a portion of the drive-through lane;
order processing means for offering at least two orderable items, the order processing means being connected to and controlling the reader means; and
vehicle-mounted transponder means for engaging in said RF communications with the RF reader means, wherein said transponder means includes input means for receiving user input indicating a selection of one of said at least two orderable items, and including means to transmit an RF signal including data regarding said selection to said reader means,
and wherein said order processing means includes means to process an order based upon said selection.

21. A system for facilitating in-vehicle ordering from a drive-through lane at a vendor's location, the system comprising:
an RFID reader having a capture zone covering at least a portion of the drive-through lane for identifying a transponder-equipped vehicle within the capture zone;
a input means for receiving user input regarding menu selections; and
an order processor for offering at least two orderable items, the order processor being connected to the input means to receive said user input.
